(19) United States
(12) Patent Application Publication
(10) Pub. No.: US 2017/0112055 A1
(43) Pub. Date: Apr. 27, 2017

(54) AGRICULTURAL HARVESTER RESIDUE SPREADER AUTOMATION

(71) Applicant: CNH Industrial America LLC, New Holland (PA)

(72) Inventors: Dries Depreitere, Koekelare (BE); Bart Vroman, Aalter (BE); John Kelley, Palatine, IL (US); Brian R. Ray, Chicago, IL (US); Todd S. Aznavorian, Naperville, IL (US)

(73) Assignee: CNH INDUSTRIAL AMERICA LLC, New Holland, PA (US)

(21) Appl. No.: 14/923,807

(22) Filed: Oct. 27, 2015

(51) Int. Cl. A01D 41/127; A01F 7/02; A01F 12/44; A01D 41/12

(52) U.S. Cl. CPC A01D 41/127; A01D 41/1243; A01F 7/02; A01F 12/444

(57) ABSTRACT

An agricultural harvester for harvesting crop material and generating residue for distribution by a spreader. A pair of deflectors are moveable by actuators to direct residue between a right limit and a left limit. An initial selection deflection selection is made and a control system compares the accurate actual heading of the agricultural harvester to the initial selection for controlling the residue pattern in accordance with prevailing winds.

### BACKGROUND OF THE INVENTION

1. Field of the Invention

The present invention relates to method and apparatus for controlling the return of crop residue to a field, and more particularly to systems that correct for changes in wind direction.

2. Description of the Related Art

An agricultural harvester, such as a combine, is a machine that is used to harvest agricultural crops such as grain. The object is to efficiently engage in several processes to severe the crop material as it stands in the field, pass it through a processing unit and separate the desired crop material from the residue that is distributed by a spreader from the aft end of the agricultural harvester. The crop residue is returned to the field desirably in a pattern that uniformly distributes it across the width of the swath of agricultural crop harvested.

It is desirable that the crop residue only be distributed where crops have previously been harvested. This becomes difficult when there is a wind blowing across the heading of the agricultural harvester. Depending upon the direction, the wind can blow the residue over crop material that has not been harvested and may damage it.

To alleviate this problem, deflectors have been adopted for the spreaders that can be adjusted right and left or center so as to properly distribute the crop material. Usually this is done manually in one form by an operator and in other cases has been done in a semi-automated fashion. However, the current systems lack the accuracy in automated control to more closely accommodate variations in heading and wind direction.

What is needed in the art, therefore, is a control system for residue deflection that more closely accommodates changes in conditions that effect the direction of the residue without operator intervention.

### SUMMARY OF THE INVENTION

The present seeks to control residue deflection in a way that frees an operator to focus on the agricultural harvester heading.

The invention, in one form, is a system for controlling residue distribution from an operator controlled agricultural harvester including a spreader apparatus for discharging the residue in a direction opposite to the heading of travel of the agricultural harvester. A pair of deflectors is positioned adjacent the spreader and adjustable to direct residue in between and up to a right limit and a left limit relative to the heading of the agricultural harvester. Actuators are provided for controlling the deflectors to direct the residue up to and between the right and left limits. A control system accurately determines the actual heading of the agricultural harvester and controls the actuators as a function of a comparison of the actual heading of the agricultural harvester relative to a prior operator selection.

In another form, the invention is an operator controlled agricultural harvester including a frame, ground wheels for supporting the frame for movement over a field, with at least a portion of the wheels being steerable to change the heading of the agricultural harvester. A power unit and power train connect to at least a portion of the ground wheels for propulsion over the field. A crop gathering and processing apparatus is mounted on the frame for collecting crop material and generating residue. A spreader apparatus is mounted on the frame for discharging residue in a direction opposite to the heading of travel of the agricultural harvester. A pair of deflectors is mounted on the frame adjacent the spreader and adjustable to direct residue in between and up to a right limit and left limit relative to the heading of the agricultural harvester. Actuators are mounted on the frame for controlling the deflectors to direct the residue up to and between the right and left limits. A control system is positioned on the frame for accurately determining the actual heading of the agricultural harvester and controlling the actuators as a function of a comparison of the actual heading of the agricultural harvester relative to a prior operator selection.

Yet another form of the invention is a method for controlling residue distribution from an operator controlled agricultural harvester having a spreader apparatus for discharging residue in a direction opposite to the direction of travel of the agricultural harvester and a pair of deflectors adjacent the spreader and adjustable in between and up to a right and left limit relative to the heading of the agricultural harvester. The method includes the steps of making a deflection selection for the deflectors, subsequently accurately determining the actual heading of the agricultural harvester, and comparing the actual heading of the agricultural harvester to the prior deflection selection to correct the deflection of the deflectors.

The present invention has the benefit of an automated control of residue direction with minimal operator input.

Another advantage is that it does so in a simplified and effective form.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a side view of an embodiment of an agricultural harvester in the form of a agriculteral harvester which may include a crop residue system of the present invention;

FIG. 2 is a fragmentary plan view of a agricultural harvester of FIG. 1 taken on lines 2-2 of FIG. 1 and showing a residue spreader apparatus;

FIG. 3 is a schematic drawing of the direction control of the residue spreader apparatus of FIGS. 1 and 2;

FIG. 4 shows the path of the agricultural harvester of FIGS. 1-3 utilizing the control system and method of the present invention; and

FIG. 5 is shows a graph of the operation of the system of FIGS. 1-4.

Corresponding reference characters indicate corresponding parts throughout the several views. The exemplification set out herein illustrates one embodiment of the invention in one form, and such exemplification is not to be construed as limiting the scope of the invention in any manner.

### DETAILED DESCRIPTION OF THE INVENTION

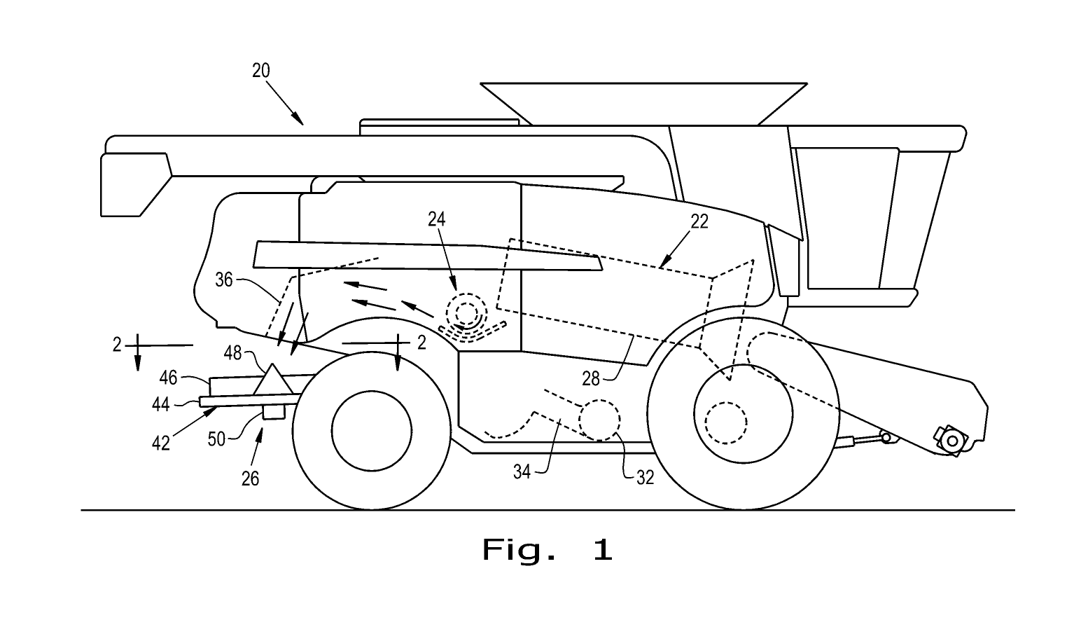

FIG. 1 shows an agricultural harvester 20 which includes the usual harvesting apparatus (not all of which is shown to facilitate an understanding of the invention). An axially oriented crop processing system 22 receives harvested crop. A crop residue treatment and distribution system 24, with a crop residue spreader 26 is positioned at the aft end of agricultural harvester 20. The crop processing system includes a cylindrical threshing rotor 28 that conveys a flow of crop material in a helical flow path. As the crop material is moved through the processing apparatus 22, the desired crop such as grain or other material is loosened and separated from crop residue such as husk and pods in a cleaning system located beneath the threshing rotor 28. The crop processing system 22 includes a blower 32, schematically depicted to aid in the separation of the desired crop from the crop residue. The blower 32 has a duct 34 extending aft in the agricultural harvester 20 towards the cleaning system and the crop residue treatment and distribution system 24.

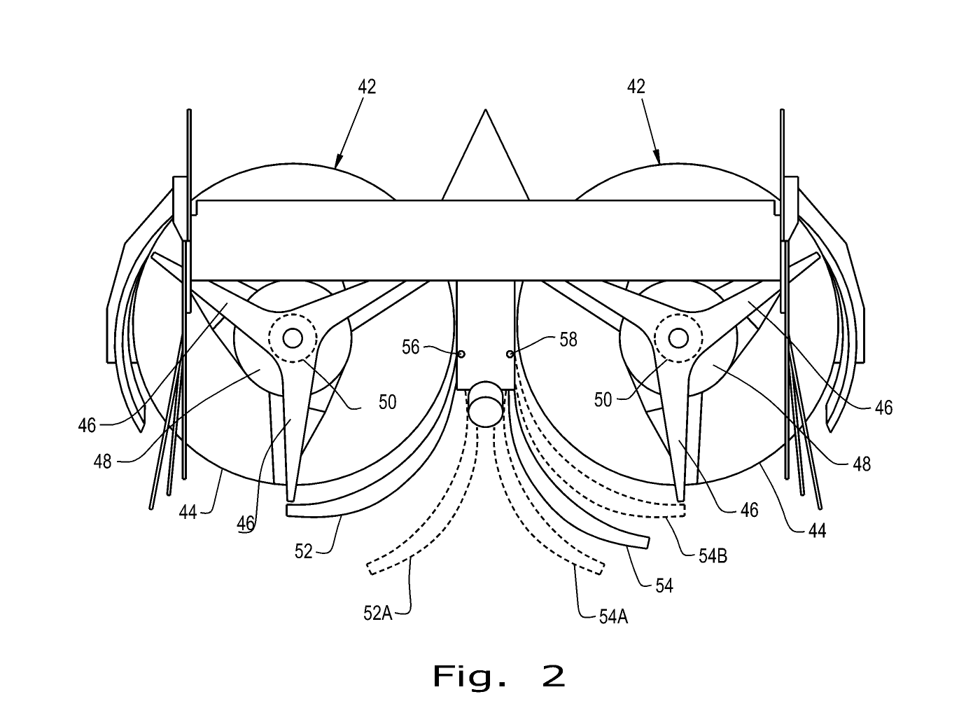

Another duct 36 directs the crop residue stream towards a pair of spreader devices 42, shown in FIG. 2. Spreader devices 42 include side-by-side disks 44 each journaled for rotation about a vertical axis and positioned laterally with respect to one another. Disks 44 have a plurality of bats 46 that act like vanes to positively direct crop residue in a lateral direction. A cone 48 extends vertically upward from each disk 44 and provides a cover for a motor 50 for each disk. The motor output shafts (not shown) cause the disks 44 to rotate as needed. Motor 50 may be in any one of a number of forms including hydraulic, air, electrical and a mechanical interconnection to a remotely positioned motor. Rotation of disks 44 is set up so that when viewed from above and looking towards the front of the agricultural harvester 20 as illustrated in FIG. 2, the right side disk rotates counterclockwise and the left disk rotates clockwise so that they propel crop residue between them aft and around and laterally.

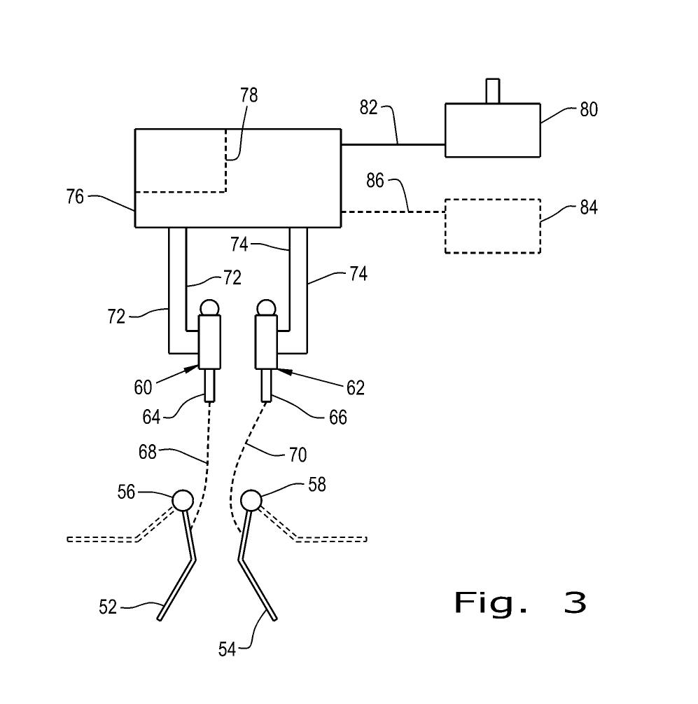

A left deflector 52 pivotally connected to the agricultural harvester 20 at point 56 and a right deflector 54 pivotally connected to the agricultural harvester 20 at 58 are positioned adjacent the spreader devices 42. The deflectors 52 and 54 are shown as pivoting around an axis that is generally parallel to the rotational axis of the disk 44 and pivotal between limits 52 A and 54 A and the solid representation of deflector 52 and dashed line 54 B. The deflectors 52 and 54 are pivoted by the control system shown in FIG. 3 to provide directional control of the residue discharged from the spreader devices 42.

Referring now to FIG. 3, the deflectors 52 and 54 are shown in schematic form connected to their pivot points 56 and 58. The deflectors 52 and 54 are displaced by left actuator 60 and right actuator 62 through left actuator output chaff 64 and right actuator output shaft 66, respectively. Mechanical interconnections 68 and 70 respectively connect the right and left actuators to the right and left deflectors 52 and 54. It should be apparent to those skilled in the art that the mechanical interconnection may take any one of a number of mechanical forms.

The actuators 60 and 62 receive control inputs from lines 72 and 74, respectively. Lines 72 and 74 extend to a control unit 76 that incorporates an accurate heading section 78 to generate a signal reflecting the calculated heading of the agricultural harvester 20. An operator input unit 80 supplies a signal to control units 76 via line 82. The signal generated by the heading section 78 is compared to the signal resulting from the operator selection device 80 to produce inputs to actuators to 60 and 62 to produce a left setting, center setting and right setting for the spreader devices 42.

The heading section 78 is preferably a GNSS system (Global Navigation Satellite System) which provides an accurate heading of the agricultural harvester 20. This is key to enabling the control system to accurately, and in real time, control the deflection of the residue from the spreader devices 42 in response to heading changes of the agricultural harvester. It is preferable that the accuracy of the heading function be improved by the use of optional implementations in section 84 through line 86, both shown in dashed lines. Additional inputs may be the addition of inertial guidance to GNSS, ground speed sensors, steering angle sensors, magnetometers, vehicle kinematic models, moving average filter and a wind sensor.

The actuators may be in a form compatible with the control unit 76 to achieve the appropriate left, center and right control states. These may be hydraulic, air or electric as appropriate.

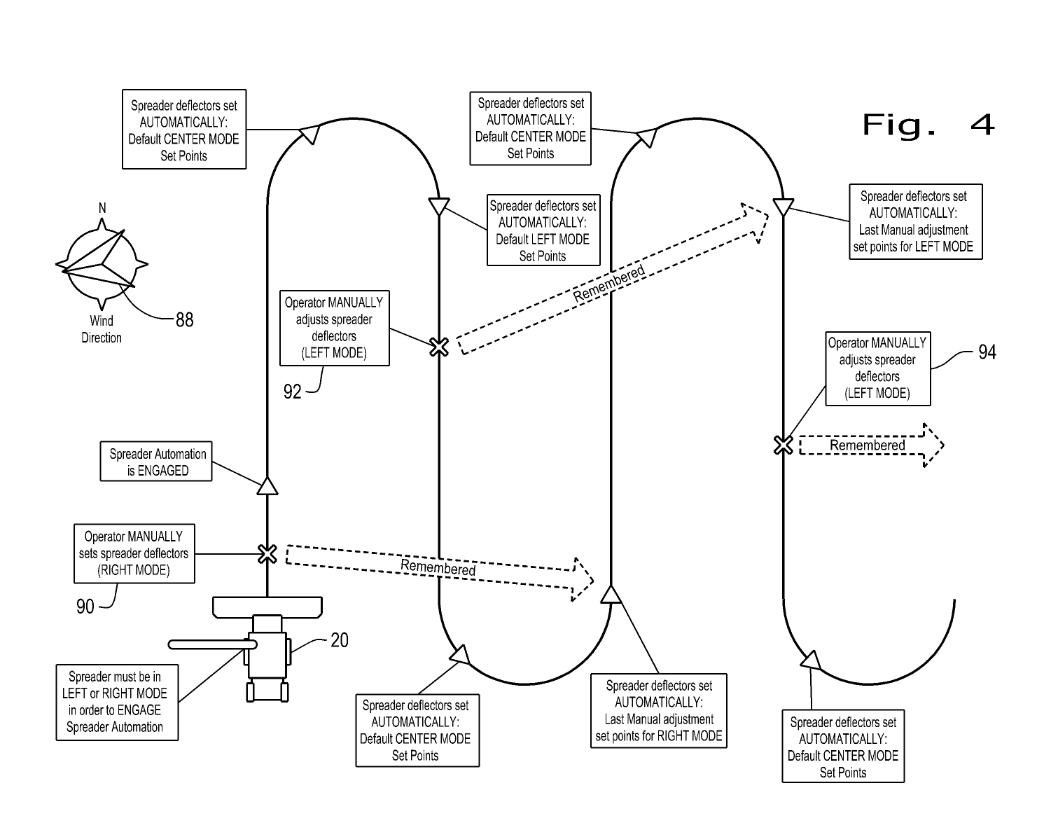

FIG. 4 illustrates the operation and method of the control system of FIG. 3. In FIG. 4, the wind direction is shown as 88 and the agricultural harvester is proceeding north in a cross wind relationship. The control system, to operate, is set into a left mode or right mode manually. As illustrated, the operator set the deflectors manually into a right mode at 90 to compensate for the wind direction 88. At that point, the automation is engaged and the heading of the agricultural harvester 20 is compared to the operator selected mode to provide control inputs to the actuators and thus the deflectors. As the agricultural harvester turns into the wind at the end of the pass, the control system automatically selects a default center mode in which the residue pattern is distributed uniformly in a direction opposite to the direction of travel of the agricultural harvester. As the agricultural harvester 20 makes a 180° turn relative to its initial direction, the control system automatically sets the deflector condition to be in a left mode so as to compensate for the wind direction 88. The additional pass and transition into the wind at the bottom of FIG. 4 causes the deflectors to be set in the center mode and then when the heading is changed 180° the spreader automatically remembers the last manual adjustment and will set the direction accordingly, in this case the right mode. It should be noted that the operator may manually adjust the spreader deflectors in between the turns as at 92 and the system is set up so that it remembers the last manual setting and adjusts the deflection based on the last setting. In the event that the operator makes no manual adjustments, the control of deflection spaced on the last operator selected setting and it is possible to have at any time thereafter an operator manual adjustment from the operator as at 94. Thus, the control of deflection is based on an accurate heading of the agricultural harvester 20 compared to the manual setting made by the operator. This allows the operator to focus on the harvesting function and relieves him from the attention required to ensure that the residue pattern only falls on portions of the field that were previously harvested.

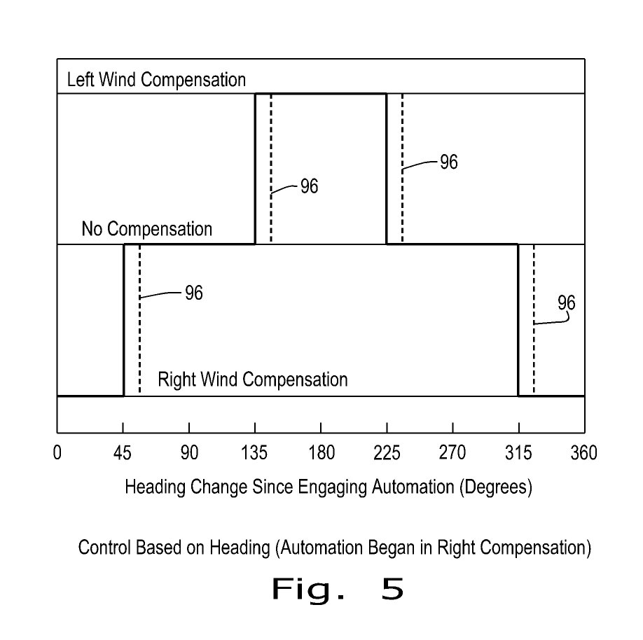

FIG. 5 shows graphically the compensation for the operation illustrated in FIG. 4 where the automation began in right compensation. Control bands, or hysteresis, illustrated by dashed lines 96, ensure that the control system will not hunt and that control inputs to the defectors will take place only after a given threshold change.

The control system operation as viewed in FIGS. 4 and 5 shows a system in which the state of the deflectors is either left, center or right. Alternatively, it is possible to control the deflectors 52 and 54 in proportion to the magnitude of the comparison between the actual heading and the prior selection. In other words, the deflectors 52 and 54 would be adjusted to more closely follow the path of the agricultural harvester 10 as it continues through the 180° turn at the end of a pass. In addition, it is possible to more closely track the path of the agricultural harvester 10 when circumventing geographical features such as a creek following an irregular path.

The system illustrated above incorporates many of the hardware items already found in agricultural harvesters and enables a greatly increased accuracy in automation of the control of residue. It does so in an efficient and effective manner.

While this invention has been described with respect to at least one embodiment, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A system for controlling residue distribution from an agricultural harvester, comprising:
a spreader apparatus for discharging residue in a direction opposite to the heading of travel of said agricultural harvester;
a pair of deflectors adjacent said spreader and adjustable to direct residue in between and up to a right limit and left limit relative to the heading of said agricultural harvester;
actuators for controlling said deflectors to direct said residue up to and between said right and left limits; and,
a control system for accurately determining the actual heading of said agricultural harvester, and controlling said actuators as a function of a comparison of the actual heading of said agricultural harvester relative to a prior operator selection.

2. A system as claimed in claim 1, wherein said operator selection is remembered after a subsequent heading change for said agricultural harvester.

3. The system as claimed in claim 2, wherein said system remembers the operator selection after multiple heading changes for said agricultural harvester.

4. The system as claimed in claim 1, wherein said operator selection is one of a right limit and a left limit.

5. The system as claimed in claim 4, wherein said operators selection occurs between a 180° change of heading for said agricultural harvester.

6. The system as claimed in claim 1, wherein said system has hysteresis built in for causing changes when the comparisons exceed given limits.

7. The system as claimed in claim 1, wherein said controller incorporates a GNSS as an accurate agricultural harvester heading system and/or GNSS with inertial guidance.

8. The system as claimed in claim 7, further comprising at least one of inertial measurement units, ground speed detectors, steering angle sensors, magnetometers, vehicle kinematic models or a moving average filter and an actual wind sensor.

9. The system as claimed in claim 1, wherein said control system controls said actuator in proportion to the magnitude of the comparison between the actual heading and said prior deflection selection.

10. An agricultural harvester comprising:
a frame;
ground wheels for supporting said frame from movement over a field, at least a portion of the said wheels being stearable to change the heading of said agricultural harvester;
a power unit and power train for connecting to at least a portion of said ground wheels for propulsion over the wheels;
a crop gathering and processing apparatus for collecting crop material and generating residue;
a spreader apparatus for discharging residue in a direction opposite to the heading of travel of said agricultural harvester;
a pair of deflectors loaded on said frame adjacent said spreader and adjustable to direct residue in between and up to a right limit and a left limit relative to the heading of said agricultural harvester;
actuators for controlling said deflectors to direct said residue up to and between said right and left limits; and,
a control system for accurately determining the actual heading of said agricultural harvester, and controlling said actuators as a function of a comparison of the actual heading of said agricultural harvester relative to a prior operator selection.

11. The agricultural harvester as claimed in claim 10, wherein said operator selection is remembered after heading changes of said agricultural harvester.

12. The agricultural harvester as claimed in claim 11, wherein the operator selection is remembered after multiple heading changes.

13. The agricultural harvester as claimed in claim 10, wherein said operator selection is one of a right limit and a left limit.

14. The agricultural harvester as claimed in claim 13, wherein said operator selection is between 180° changes in headings.

15. The agricultural harvester as claimed in claim 10, wherein said control system has hysteresis built in for causing changes when the comparisons exceed given limits.

16. The agricultural harvester as claimed in claim 10, wherein said control system incorporates at least one of a GNSS, GNSS and inertial system, inertial measurement units, ground speed, steering angle sensors, magnetometers, vehicle kinematic models, moving average filters and an actual wind sensor.

17. The agricultural harvester as claimed in claim 10, wherein said control system controls said actuator in proportion to the magnitude of the comparison between the actual heading and said prior deflection selection.

18. A method for controlling residue distribution from an agricultural harvester having a spreader apparatus for discharging residue in a direction opposite to the direction of travel of the agricultural harvester, a pair of deflectors adjacent the spreader and adjustable in between and up to a right and left limit relative to the heading of said agricultural harvester, said method comprising the steps of:
making a deflection selection for said deflectors;
subsequently accurately determining the actual heading of the agricultural harvester; and,
comparing the actual heading of the agricultural harvester to said prior deflection selection to correct the deflection of said deflectors.

19. The method as claimed in claim 18, further comprising multiple accurate heading determinations and comparisons to said deflection selection.

20. The method as claimed in claim 18, wherein said accurate determination of the actual heading of said agricultural harvester includes at least one of a GNSS, GNSS inertial measurement unit, ground speed, steering angle sensors, magnetometers, vehicle kinematic models, moving average filter and an actual wind sensor.

21. The method as claimed in claim 18, further comprising at least one additional selection after the initial deflection selection.

22. The method as claimed in claim 21, wherein said deflection selection occurs after a 180° change in the agricultural harvester heading.

23. The method as claimed in claim 18, wherein said correction step is proportional to the magnitude of the comparison between the actual heading and the prior deflection selection.
